(19) United States
(12) Patent Application Publication
(10) Pub. No.: US 2025/0292596 A1
(43) Pub. Date: Sep. 18, 2025

(54) MULTI-STAGE MULTI-VIEW OBJECT DETECTION

(71) Applicant: QUALCOMM Incorporated, San Diego, CA (US)

(72) Inventors: Per CRONVALL, Linköping (SE); Gustav Nils Ture PERSSON, Ljungsbro (SE); Jacob ROLL, Linköping (SE); Per Albert SIDEN, Linköping (SE); Andreas EIDEHALL, Linköping (SE); Peter Leif LINDSKOG, Linköping (SE)

(21) Appl. No.: 18/607,077

(22) Filed: Mar. 15, 2024

(51) Int. Cl. G06V 20/64; G06T 3/4046; G06T 7/73; G06V 10/40; G06V 10/82; G06V 20/58

(52) U.S. Cl. CPC G06V 20/64; G06T 3/4046; G06T 7/73; G06V 10/40; G06V 10/82; G06V 20/58; G06T 2207/20081; G06T 2207/20084; G06T 2207/30252

(57) ABSTRACT

Systems and techniques are described herein for object detection. For example, a computing device can extract, by an encoder of the computing device, a plurality of features from one or more images of an environment of the computing device. The computing device can determine, based on the plurality of features, a first detection of one or more objects and three-dimensional (3D) coordinates for the one or more objects. The computing device can back-project the 3D coordinates of the one or more objects onto the one or more images. The computing device can determine one or more regions of at least one first image of the one or more images based on the back-projection of the 3D coordinates of the one or more objects. computing device determine, based on the one or more regions of the at least one first image, a second detection of the one or more objects.

### FIELD

The present disclosure generally relates to object detection. For example, aspects of the present disclosure relate to an efficient multi-stage (e.g., two-stage) multi-view object detection, such as three-dimensional (3D) object detection.

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors (e.g., camera sensors) to gather information about the environment, as well as processing systems to process the information gathered, such as for route planning, navigation, collision avoidance, environment modelling/rendering, etc. One example of such a system is a multi-view 3D object detector. Currently, typical multi-view 3D object detectors employ either a bird's eye view (BEV) model or a detection transformer model. Object detection models require high resolution input images for optimal detection performance, which is computationally expensive. Alternatively, downsampled input images with lower resolutions can be used that require less computation, but result in a degraded detection performance.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for object detection. According to at least one example, an apparatus is provided for object detection. The apparatus includes at least one memory and at least one processor coupled to the at least one memory and configured to: extract, using an encoder, a plurality of features from one or more images of an environment of the apparatus; determine, based on the plurality of features, a first detection of one or more objects and three-dimensional (3D) coordinates for the one or more objects; back-project the 3D coordinates of the one or more objects onto the one or more images; determine one or more regions of at least one first image of the one or more images based on the back-projection of the 3D coordinates of the one or more objects; and determine, based on the one or more regions of the at least one first image, a second detection of the one or more objects.

In another illustrative example, a method is provided for object detection at a device. The method includes: extracting, by an encoder of the device, a plurality of features from one or more images of an environment of the device; determining, based on the plurality of features, a first detection of one or more objects and three-dimensional (3D) coordinates for the one or more objects; back-projecting the 3D coordinates of the one or more objects onto the one or more images; determining one or more regions of at least one first image of the one or more images based on the back-projection of the 3D coordinates of the one or more objects; and determining, based on the one or more regions of the at least one first image, a second detection of the one or more objects.

In another illustrative example, a non-transitory computer-readable medium of a device is provided, the non-transitory computer-readable medium having stored thereon instructions that, when executed by one or more processors, cause the one or more processors to: extract, using an encoder, a plurality of features from one or more images of an environment of the apparatus; determine, based on the plurality of features, a first detection of one or more objects and three-dimensional (3D) coordinates for the one or more objects; back-project the 3D coordinates of the one or more objects onto the one or more images; determine one or more regions of at least one first image of the one or more images based on the back-projection of the 3D coordinates of the one or more objects; and determine, based on the one or more regions of the at least one first image, a second detection of the one or more objects.

In another illustrative example, an apparatus is provided for object detection. The apparatus includes: means for extracting, by an encoder of the device, a plurality of features from one or more images of an environment of the device; means for determining, based on the plurality of features, a first detection of one or more objects and three-dimensional (3D) coordinates for the one or more objects; means for back-projecting the 3D coordinates of the one or more objects onto the one or more images; means for determining one or more regions of at least one first image of the one or more images based on the back-projection of the 3D coordinates of the one or more objects; and means for determining, based on the one or more regions of the at least one first image, a second detection of the one or more objects.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described herein is, can be part of, or can include a mobile device, a smart or connected device, a camera system, and/or an extended reality (XR) device (e.g., a virtual reality (VR) device, an augmented reality (AR) device, or a mixed reality (MR) device). In some examples, each apparatus can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an architecture of an image capture and processing system, in accordance with aspects of the present disclosure.

FIG. 2 is a diagram illustrating an architecture of an example system, in accordance with some aspects of the disclosure.

FIG. 3A is a diagram illustrating an example of a fully-connected neural network, in accordance with some examples of the present disclosure.

FIG. 3B is a diagram illustrating an example of a locally-connected neural network, in accordance with some examples of the present disclosure.

FIG. 3C is a diagram illustrating an example of a convolutional neural network (CNN), in accordance with some examples of the present disclosure.

FIG. 3D is a diagram illustrating an example of a deep convolutional network (DCN) for recognizing visual features from an image, in accordance with some examples of the present disclosure.

FIG. 4 is a block diagram illustrating an example DCN, in accordance with some examples of the present disclosure.

FIG. 5 is a diagram illustrating an example of a vehicle with a sensor suite, according to various aspects of the present disclosure.

FIG. 6 is a diagram illustrating an example of a process for efficient two-stage multi-view 3D object detection, according to various aspects of the present disclosure.

FIG. 7 is a diagram illustrating an example of details of the 3D to two-dimensional (2D) back-projection performed in the process of FIG. 6, according to various aspects of the present disclosure.

FIG. 8 is a diagram illustrating an example of a process of applying cross-attention to multiple regions, according to various aspects of the present disclosure.

FIG. 9 is a flow diagram illustrating an example of a process for object detection, in accordance with some examples.

FIG. 10 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As mentioned, systems and devices (e.g., autonomous vehicles, such as autonomous and semi-autonomous cars, drones, mobile robots, mobile devices, extended reality (XR) devices, and other suitable systems or devices) increasingly include multiple sensors (e.g., camera sensors) to gather information about the environment, as well as processing systems to process the information gathered, such as for route planning, navigation, collision avoidance, environment modelling/rendering, etc. One example of such a system is a multi-view 3D object detector. Currently, typical state-of-the-art multi-view 3D object detectors employ either a bird's eye view (BEV) model or a detection transformer model. To achieve maximal performance, these object detection models require high resolution input images and intermediate feature representations, which can result in a computationally expensive solution. Alternatively, downsampled input images (or low resolution images from a lower-resolution sensor) and/or lower resolution feature representations can be used, but at the expense of detection performance.

As such, improved systems and techniques for efficient multi-view 3D object detection can be beneficial.

In one or more aspects, systems, apparatuses, processes (also referred to as methods), and computer-readable media (collectively referred to herein as “systems and techniques”) are described herein for providing an efficient multi-stage (e.g., two-stage) multi-view object detection, such as three-dimensional (3D) object detection. In one or more examples, the systems and techniques extract high resolution patches (e.g., regions) from input images based on 3D detections, and use these patches at full (e.g., high) resolution for object detection. In some examples, multiple patches for the same object can be processed individually and fused together to obtain a set of combined confidences and/or a model can apply cross-attention to combine the information from each separate patch. Further, patch selection from multi-view sources can be guided based on where a patch is located with reference to a center of an image, occlusion values, or machine learning training.

In one or more aspects, during operation of the systems and techniques for detecting one or more objects, an encoder of a device (e.g., a vehicle, such as an autonomous vehicle, a computing device or system of the vehicle, such as an Advanced Driver Assistance Systems (ADAS) system, or other type of device) can extract a plurality of features from one or more images of an environment of the device. The device can then determine (e.g., using a first detector or a first detector stage of an object detection system), based on the plurality of features, a first detection of the one or more objects and 3D coordinates (e.g., world coordinates) for the one or more objects. World coordinates refer to coordinates in a 3D coordinate system relative to the device (e.g., a vehicle or device or system of the vehicle, such as an ego vehicle, or other device), expressed in physical dimensions (e.g., meters). The device can back-project the 3D coordinates of the one or more objects onto the one or more images. The device can then determine one or more regions (e.g., each in the form of a bounding box) of at least one first image of the one or more images, based on the back-projection of the 3D coordinates of the one or more objects. The device can determine (e.g., using a second detector or a second detector stage of the object detection system), based on the one or more regions of the at least one first image, a second detection of the one or more objects.

In some aspects, the device can downsample the one or more images to produce one or more downsampled images. In such aspects, the encoder can extract the plurality of features from the one or more downsampled images. In one or more examples, the one or more images can have a higher resolution than the one or more downsampled images. In some examples, the one or more images can include a larger number of images than the one or more downsampled images. In one or more examples, the one or more images can be two-dimensional images (e.g., an image H×W image having a height (H) dimension and a width (W) dimension).

In some examples, one or more camera sensors of the device can obtain the one or more images of the environment of the device. In one or more examples, the device can determine a subset of camera sensors of the one or more camera sensors for the one or more regions of the at least one first image based on: the subset of camera sensors having views within which the one or more objects are centrally located (e.g., more centrally located than within one or more views of one or more other camera sensors), the subset of camera sensors having views where the one or more objects are least occluded as compared to views of other camera sensors of the one or more camera sensors, and/or machine learning training for selecting the subset of the camera sensors.

In one or more examples, determining the second detection of the one or more objects can be further based on the one or more regions being processed individually. In some examples, determining the second detection of the one or more objects can be further based on at least portions of the one or more regions being processed as a single composite region comprising the at least portions of the one or more regions. In one or more examples, determining the second detection of the one or more objects can be further based on the one or more regions being processed with one or more cross-attention layers of a transformer neural network applied to the one or more regions. In some examples, the device can project the plurality of features to a bird's eye view (BEV).

In one or more aspects, the images are typically downsampled for computational efficiency reasons. However, the systems and techniques can also be beneficial without performing downsampling, since the second detector (or second detector stage of the object detection system) might be able to retrieve information that would otherwise be lost in the BEV feature projection or elsewhere in the model. In some aspects, the second detector (or second detector stage of the object detection system) may serve other purposes beyond pure detection and classification. In one or more examples, the second detector (or second detector stage of the object detection system) could also perform pose estimation or any other object attribute classification or regression. As used herein, the terms detector and detector stage are used interchangeably, and can refer to as an object detector (e.g., a neural network model or other system or algorithm configured to perform object detection) or an object detection process performed by an object detector. In some cases, a detector may or may not be a detector in itself. For example, in some cases, a second detector may be a classifier determining if an extracted region (e.g., from a first detector) contains an object of interest or not or if the object in the region possesses a certain attribute. In another example, a detector may also be a regressor estimating a property, or set of properties, of the object in the region. In other examples, a detector can be a combination of a detector, classifier, and/or regressor.

Additional aspects of the present disclosure are described in more detail below.

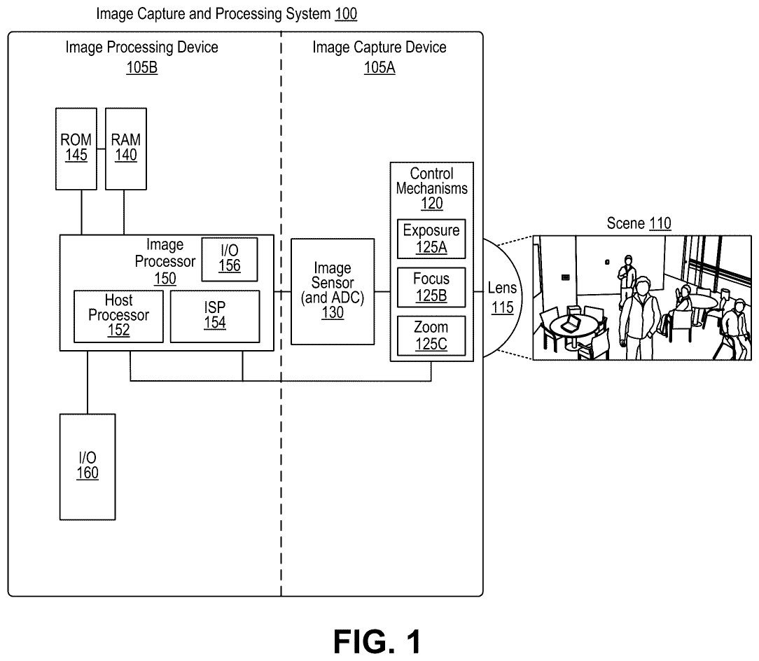

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

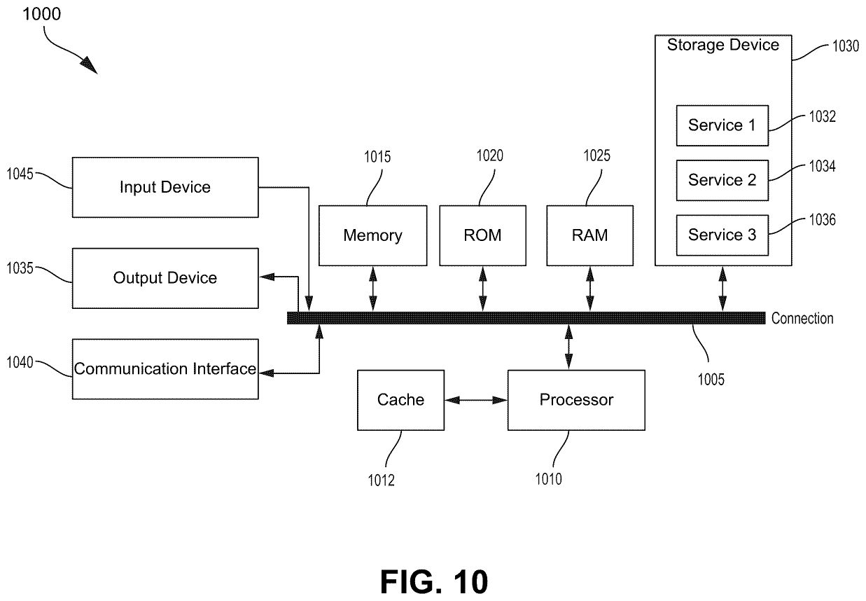

The image processor 150 may include one or more processors, such as one or more image signal processors (ISPs) (including ISP 154), one or more host processors (including host processor 152), and/or one or more of any other type of processor 1010 discussed with respect to the computing system 1000 of FIG. 10. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

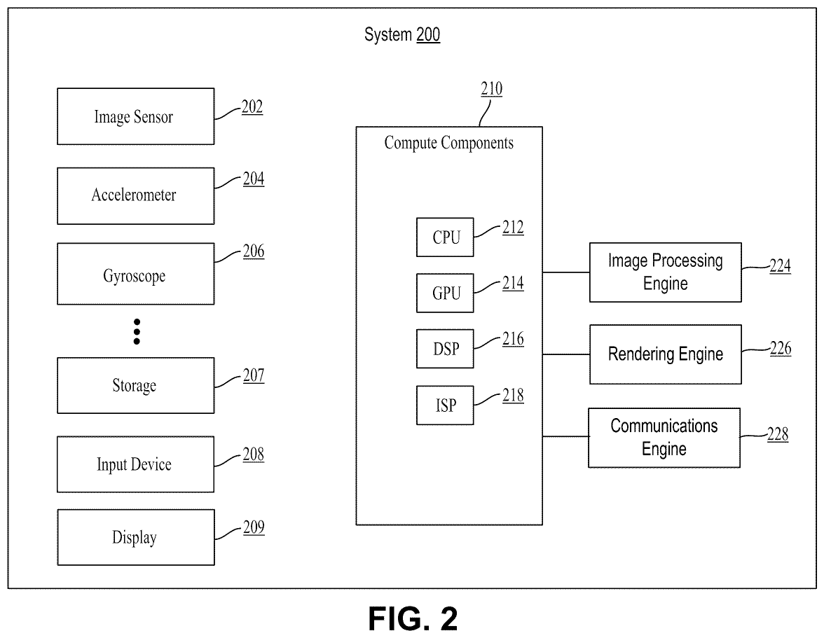

In some examples, the system 200 of FIG. 2 can include the image capture and processing system 100, the image capture device 105A, the image processing device 105B, or a combination thereof.

FIG. 2 is a diagram illustrating an architecture of an example system 200, in accordance with some aspects of the disclosure. The system 200 can run (or execute) applications and implement operations. In some examples, the system 200 can perform tracking and localization, and/or mapping of an environment in the physical world (e.g., a scene). For example, the system 200 can generate a map (e.g., a 3D map) of an environment in the physical world, and display the map on the display 209. The display 209 can include a glass, a screen, a lens, a projector, and/or other display mechanism.

In this illustrative example, the system 200 includes one or more image sensors 202 (e.g., cameras), an accelerometer 204, a gyroscope 206, storage 207, compute components 210, an engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the system 200 can include one or more other sensors (e.g., one or more inertial measurement units (IMUs), RADARs, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 2. While various components of the system 200, such as the image sensor 202, may be referenced in the singular form herein, it should be understood that the system 200 may include multiple of any component discussed herein (e.g., multiple image sensors 202).

The system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1045 discussed herein, or any combination thereof. In some cases, the image sensor 202 can capture images that can be processed for interpreting gesture commands.

The system 200 can also communicate with one or more other electronic devices (wired or wirelessly). For example, communications engine 228 can be configured to manage connections and communicate with one or more electronic devices. In some cases, the communications engine 228 can correspond to the communications interface 1040 of FIG. 10.

In some implementations, the one or more image sensors 202, the accelerometer 204, the gyroscope 206, storage 207, compute components 210, engine 220, image processing engine 224, and rendering engine 226 can be part of the same computing device. For example, in some cases, the one or more image sensors 202, the accelerometer 204, the gyroscope 206, storage 207, compute components 210, engine 220, image processing engine 224, and rendering engine 226 can be integrated into a vehicle, an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, application data, face recognition data, occlusion data, etc.), data from the engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the system 200) can be configured to also capture depth information. For example, in some implementations, the image sensor 202 (and/or other camera) can include an RGB-depth (RGB-D) camera. In some cases, the system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the system 200 and can generate acceleration measurements based on the detected acceleration. In some cases, the accelerometer 204 can provide one or more translational vectors (e.g., up/down, left/right, forward/back) that can be used for determining a position or pose of the system 200. The gyroscope 206 can detect and measure the orientation and angular velocity of the system 200. For example, the gyroscope 206 can be used to measure the pitch, roll, and yaw of the system 200. In some cases, the gyroscope 206 can provide one or more rotational vectors (e.g., pitch, yaw, roll). In some examples, the image sensor 202 and/or the engine 220 can use measurements obtained by the accelerometer 204 (e.g., one or more translational vectors) and/or the gyroscope 206 (e.g., one or more rotational vectors) to calculate the pose of the system 200. As previously noted, in other examples, the system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the system 200, using a combination of one or more accelerometers, one or more gyroscopes, and/or one or more magnetometers. In some examples, the one or more sensors can output measured information associated with the capture of an image captured by the image sensor 202 (and/or other camera of the system 200) and/or depth information obtained using one or more depth sensors of the system 200.

The output of one or more sensors (e.g., the accelerometer 204, the gyroscope 206, one or more IMUs, and/or other sensors) can be used by the engine 220 to determine a pose of the system 200 and/or the pose of the image sensor 202 (or other camera of the system 200). In some cases, the pose of the system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees Of Freedom (3DoF), which refers to the three angular components (e.g., roll, pitch, and yaw).

In some cases, a device tracker (not shown) can use the measurements from the one or more sensors and image data from the image sensor 202 to track a pose (e.g., a 6DoF pose) of the system 200. For example, the device tracker can fuse visual data (e.g., using a visual tracking solution) from the image data with inertial data from the measurements to determine a position and motion of the system 200 relative to the physical world (e.g., the scene) and a map of the physical world. As described below, in some examples, when tracking the pose of the system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the system 200 within the scene and the 3D map of the scene, etc. The 3D map can provide a digital representation of a scene in the real/physical world. In some examples, the 3D map can anchor location-based objects and/or content to real-world coordinates and/or objects. The system 200 can use a mapped scene (e.g., a scene in the physical world represented by, and/or associated with, a 3D map) to merge virtual content or objects with the physical environment.

In some aspects, the pose of image sensor 202 and/or the system 200 as a whole can be determined and/or tracked by the compute components 210 using a visual tracking solution based on images captured by the image sensor 202 (and/or other camera of the system 200). For instance, in some examples, the compute components 210 can perform tracking using computer vision-based tracking, model-based tracking, and/or simultaneous localization and mapping (SLAM) techniques. For instance, the compute components 210 can perform SLAM or can be in communication (wired or wireless) with a SLAM system. SLAM refers to a class of techniques where a map of an environment (e.g., a map of an environment being modeled by system 200) is created while simultaneously tracking the pose of a camera (e.g., image sensor 202) and/or the system 200 relative to that map. The map can be referred to as a SLAM map, and can be three-dimensional (3D). The SLAM techniques can be performed using color or grayscale image data captured by the image sensor 202 (and/or other camera of the system 200), and can be used to generate estimates of 6DoF pose measurements of the image sensor 202 and/or the system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, sensor data, such as images captured by the image capture and processing system 100 of FIG. 1, point clouds captured by LIDAR/RADAR sensors, etc., may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

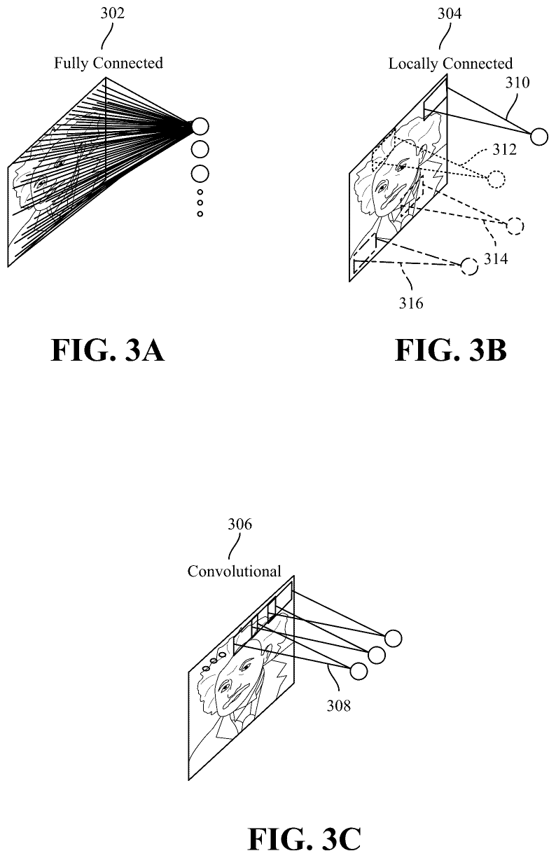

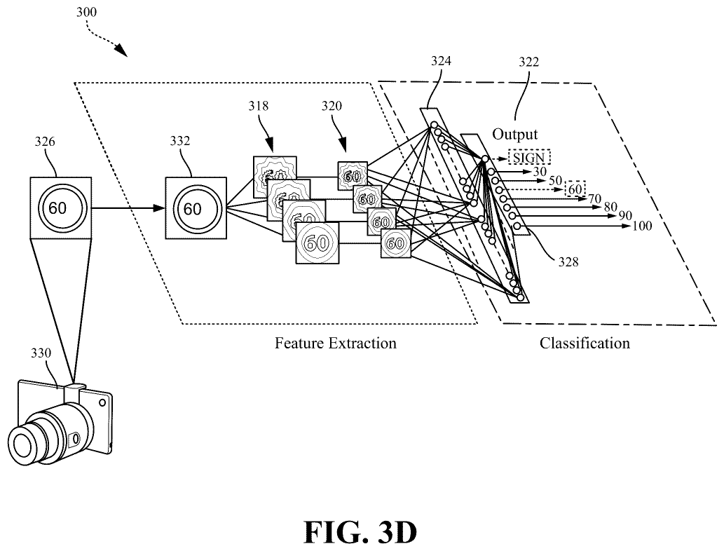

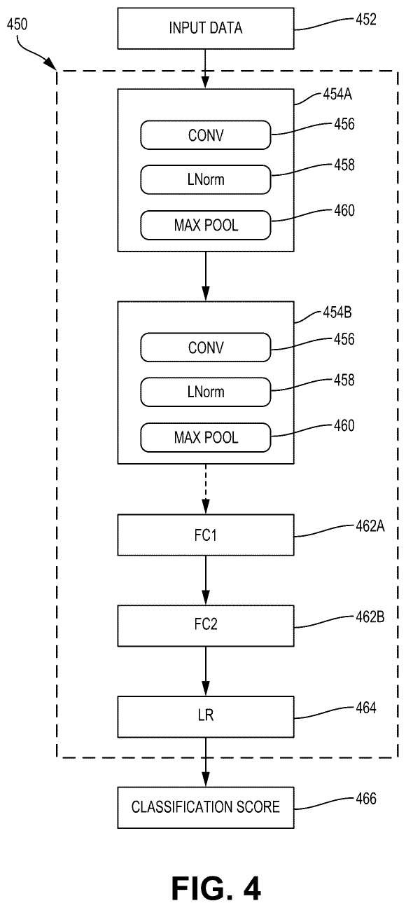

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 3A-FIG. 4.

Neural networks may be designed with a variety of connectivity patterns. In feed- forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 3A illustrates an example of a fully connected neural network 302. In a fully connected neural network 302, a neuron in a first layer may communicate its output to every neuron in a second layer, so that each neuron in the second layer will receive input from every neuron in the first layer. FIG. 3B illustrates an example of a locally connected neural network 304. In a locally connected neural network 304, a neuron in a first layer may be connected to a limited number of neurons in the second layer. More generally, a locally connected layer of the locally connected neural network 304 may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 3C illustrates an example of a convolutional neural network 306. The convolutional neural network 306 may be configured such that the connection strengths associated with the inputs for each neuron in the second layer are shared (e.g., 308). Convolutional neural networks may be well suited to problems in which the spatial location of inputs is meaningful. Convolutional neural network 306 may be used to perform one or more aspects of video compression and/or decompression, according to aspects of the present disclosure.

One type of convolutional neural network is a deep convolutional network (DCN). FIG. 3D illustrates a detailed example of a DCN 300 designed to recognize visual features from an image 326 input from an image capturing device 330, such as an image capture and processing system 100 of FIG. 1. The DCN 300 of the current example may be trained to identify traffic signs and a number provided on the traffic sign. Of course, the DCN 300 may be trained for other tasks, such as identifying lane markings or identifying traffic lights.

The DCN 300 may be trained with supervised learning. During training, the DCN 300 may be presented with an image, such as the image 326 of a speed limit sign, and a forward pass may then be computed to produce an output 322. The DCN 300 may include a feature extraction section and a classification section. Upon receiving the image 326, a convolutional layer 332 may apply convolutional kernels (not shown) to the image 326 to generate a first set of feature maps 318. As an example, the convolutional kernel for the convolutional layer 332 may be a 5×5 kernel that generates 28×28 feature maps. In the present example, because four different feature maps are generated in the first set of feature maps 318, four different convolutional kernels were applied to the image 326 at the convolutional layer 332. The convolutional kernels may also be referred to as filters or convolutional filters.

The first set of feature maps 318 may be subsampled by a max pooling layer (not shown) to generate a second set of feature maps 320. The max pooling layer reduces the size of the first set of feature maps 318. That is, a size of the second set of feature maps 320, such as 14×14, is less than the size of the first set of feature maps 318, such as 28×28. The reduced size provides similar information to a subsequent layer while reducing memory consumption. The second set of feature maps 320 may be further convolved via one or more subsequent convolutional layers (not shown) to generate one or more subsequent sets of feature maps (not shown).

In the example of FIG. 3D, the second set of feature maps 320 is convolved to generate a first feature vector 324. Furthermore, the first feature vector 324 is further convolved to generate a second feature vector 328. Each feature of the second feature vector 328 may include a number that corresponds to a possible feature of the image 326, such as “sign,” “60,” and “100.” A softmax function (not shown) may convert the numbers in the second feature vector 328 to a probability. As such, an output 322 of the DCN 300 is a probability of the image 326 including one or more features.

In the present example, the probabilities in the output 322 for “sign” and “60” are higher than the probabilities of the others of the output 322, such as “30,” “40,” “50,” “70,” “80,” “90,” and “100”. Before training, the output 322 produced by the DCN 300 is likely to be incorrect. Thus, an error may be calculated between the output 322 and a target output. The target output is the ground truth of the image 326 (e.g., “sign” and “60”). The weights of the DCN 300 may then be adjusted so the output 322 of the DCN 300 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 322 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 320) receiving input from a range of neurons in the previous layer (e.g., feature maps 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 4 is a block diagram illustrating an example of a deep convolutional network 450. The deep convolutional network 450 may include multiple different types of layers based on connectivity and weight sharing. As shown in FIG. 4, the deep convolutional network 450 includes the convolution blocks 454A, 454B. Each of the convolution blocks 454A, 454B may be configured with a convolution layer (CONV) 456, a normalization layer (LNorm) 458, and a max pooling layer (MAX POOL) 460. Of note, the layers illustrated with respect to convolution blocks 454A and 454B are examples of layers that may be included in a convolution layer and are not intended to be limiting and other types of layers may be included in any order.

The convolution layers 456 may include one or more convolutional filters, which may be applied to the input data 452 to generate a feature map. Although only two convolution blocks 454A, 454B are shown, the present disclosure is not so limiting, and instead, any number of convolution blocks (e.g., convolution blocks 454A, 454B) may be included in the deep convolutional network 450 according to design preference. The normalization layer 458 may normalize the output of the convolution filters. For example, the normalization layer 458 may provide whitening or lateral inhibition. The max pooling layer 460 may provide down sampling aggregation over space for local invariance and dimensionality reduction.

The parallel filter banks, for example, of a deep convolutional network may be loaded on a processor such as a CPU or GPU, or any other type of processor 1010 discussed with respect to the computing system 1000 of FIG. 10 to achieve high performance and low power consumption. In alternative aspects, the parallel filter banks may be loaded on a DSP or an ISP of the computing system 1000 of FIG. 10. In addition, the deep convolutional network 450 may access other processing blocks that may be present on the computing system 1000 of FIG. 10, such as sensor processor and navigation module, dedicated, respectively, to sensors and navigation.

The deep convolutional network 450 may also include one or more fully connected layers, such as layer 462A (labeled “FC1”) and layer 462B (labeled “FC2”). The deep convolutional network 450 may further include a logistic regression (LR) layer 464. Between each layer 456, 458, 460, 462A, 462B, 464 of the deep convolutional network 450 are weights (not shown) that are to be updated. The output of each of the layers (e.g., 456, 458, 460, 462A, 462B, 464) may serve as an input of a succeeding one of the layers (e.g., 456, 458, 460, 462A, 462B, 464) in the deep convolutional network 450 to learn hierarchical feature representations from input data 452 (e.g., images, audio, video, sensor data and/or other input data) supplied at the first of the convolution blocks 454A. The output of the deep convolutional network 450 is a classification score 466 for the input data 452. The classification score 466 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 450 may output probabilities that an input data, such as an image, includes certain features. The deep convolutional network 450 may then be modified to extract (e.g., output) certain features. Additionally, DCNs may be added to extract other features as well. This set of DCNs may function as feature extractors to identify features in an image. In some cases, feature extractors may be used as a backbone for additional ML network components to perform further operations, such as localization, image segmentation, object detection, etc.

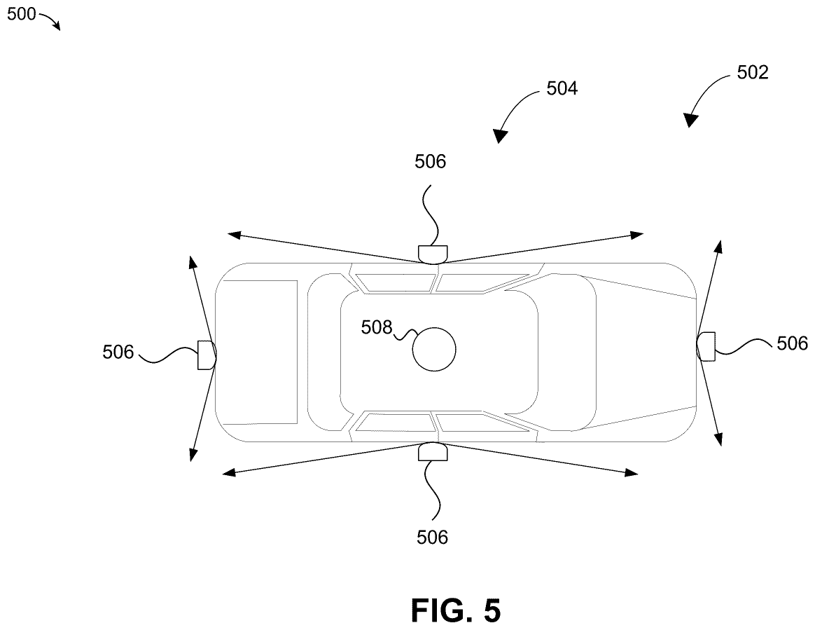

FIG. 5 is a diagram illustrating an example of a vehicle (e.g., an autonomous vehicle) 502 with a sensor suite 504. The source sensor suite 504 is shown to include four cameras 506 and one Light Detection and Ranging (LiDAR) sensor 508. Each of the cameras 506 may be a surround view (SV) camera or a fisheye camera, for example, with a wide (e.g., nearly 180 degree) field of view. The LiDAR sensor 508 may be a 64-layer LiDAR sensor. In one or more examples, the source sensor suite 504 of the source vehicle 502 may include a greater or lower number of cameras 506 and/or LiDAR sensors 508, than as shown in FIG. 5.

Collectively, the source sensor suite 504 may have certain intrinsic parameters (e.g., focal lengths of the cameras 506, optical centers of the cameras 506, skew coefficients of the cameras 506, frame-capture rates of the cameras 506, scan patterns of the LiDAR sensor 508, and/or intensity channels of the LiDAR sensor 508) and certain extrinsic parameters (e.g., positions of the cameras 506 and the LiDAR sensor 508 on source vehicle 502).

Data from at least a portion of the source sensor suite 504 may be used to train machine-learning models to perform specific tasks such as static three dimensional (3D) and/or bird's eye view (BEV) tasks, for instance: 3D lane detection, 3D object detection (e.g., traffic-light detection, and/or sign detection), and/or static two-dimensional (2D) perspective-view (PV) tasks for instance: image-based lane detection and/or 2D object detection and/or other tasks.

As previously mentioned, increasingly systems and devices (e.g., autonomous vehicles, such as autonomous and semi-autonomous cars, drones, mobile robots, mobile devices, extended reality (XR) devices, and other suitable systems or devices) employ multiple sensors (e.g., camera sensors) to gather information about the environment, as well as processing systems to process the information gathered, such as for route planning, navigation, collision avoidance, environment modelling/rendering, etc. An example of such a system is a multi-view 3D object detector. Typical current state-of-the-art multi-view 3D object detectors employ either a bird's eye view (BEV) model or a detection transformer model. To achieve maximal performance, these object detection models need high resolution input images and intermediate feature representations, which can lead to a computationally expensive solution. Alternatively, downsampled input images and/or lower resolution feature representations may be used, but at the expense of detection performance. Therefore, improved systems and techniques for efficient multi-view 3D object detection can be useful.

In one or more aspects, the systems and techniques provide an efficient two-stage multi-view 3D object detection. In one or more examples, the systems and techniques can extract high resolution patches (e.g., one or more regions) from input images based on 3D detections, and use these patches at full resolution (e.g., high resolution) for object detection. In some examples, multiple patches for the same object may be processed individually and fused together to obtain a set of combined confidences and/or a model may apply cross-attention to combine the information from each separate patch. Further, patch selection from multi-view sources may be guided based on where a patch is located with reference to a center of an image, occlusion values, or machine learning training.

In one or more examples, during operation of the systems and techniques for detecting one or more objects, a device (e.g., a vehicle, such as an autonomous vehicle) may downsample one or more images of an environment of the device to produce one or more downsampled images. An encoder of the device may extract a plurality of features from the one or more downsampled images. A first detector of the device may then determine, based on the plurality of features, a first detection of the one or more objects and 3D coordinates (e.g., world coordinates) for the one or more objects. The device may back-project the 3D coordinates of the one or more objects onto the one or more images. The device may then determine one or more regions (e.g., each in the form of a bounding box) of at least one first image of the one or more images, based on the back-projection of the 3D coordinates of the one or more objects. A second detector of the device may determine, based on the one or more regions of the at least one first image, a second detection of the one or more objects.

In one or more examples, the one or more images may have a higher resolution than the one or more downsampled images. In some examples, the one or more images may include a larger number of images than the one or more downsampled images. In one or more examples, the one or more images may be 2D images. In some examples, the device may project the plurality of features to a bird's eye view (BEV). In some examples, the 3D coordinates may be world coordinates. In one or more examples, the device may be a vehicle, such as an autonomous vehicle or an ego vehicle.

In some examples, one or more camera sensors of the device may obtain the one or more images of the environment of the device. In one or more examples, the device may determine a subset of camera sensors of the one or more camera sensors for the one or more regions of the at least one first image based on: the subset of camera sensors having views within which the one or more objects are centrally located (e.g., more centrally located as compared to the location of the one or more objects within one or more views of one or more other camera sensors), the subset of camera sensors having views where the one or more objects are least occluded as compared to views of other camera sensors of the one or more camera sensors, and/or machine learning training for selecting the subset of the camera sensors.

In one or more examples, determining, by the second detector of the device, the second detection of the one or more objects may be further based on the one or more regions being processed individually. In some examples, determining, by the second detector of the device, the second detection of the one or more objects may be further based on at least portions of the one or more regions being processed as a single composite region comprising the at least portions of the one or more regions. In one or more examples, determining, by the second detector of the device, the second detection of the one or more objects may be further based on the one or more regions being processed with one or more cross-attention layers of a transformer neural network applied to the one or more regions.

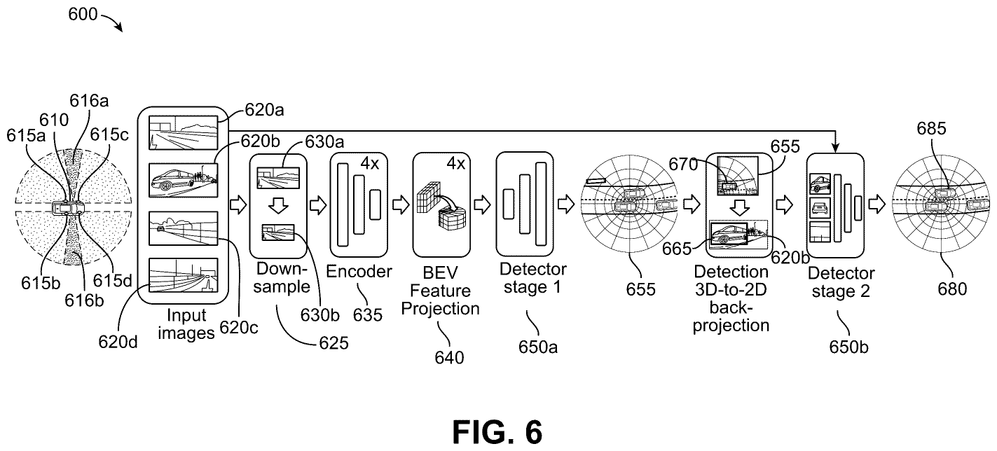

FIG. 6 shows an example of efficient multi-view 3D object detection. In particular, FIG. 6 is a diagram illustrating an example of a process 600 for efficient two-stage multi-view 3D object detection. The process 600 is a two-stage approach, where the second stage utilizes a higher resolution input, but operates only on selected regions of input.

In FIG. 6, a device 610 in the form of a vehicle is shown. In one or more examples, the device 610 may be an autonomous vehicle or an ego vehicle. The device 610 (e.g., vehicle) is shown to be implemented with four camera sensors 615a, 615b, 615c, and 615d (e.g., image sensors), where each camera sensor has a respective field of view (FOV). As shown, the FOVs of the cameras are partially overlapping as indicated by area 616a and area 616b (e.g., area 616a corresponds to overlapping fields of view of camera 615a and camera 615c and area 616b corresponds to overlapping fields of view of camera 615b and camera 615d). In one illustrative example, each camera sensor 615a, 615b, 615c, 615d may have a FOV of approximately 100 degrees. In one or more examples, the device 610 may have a greater or lesser number of camera sensors 615a, 615b, 615c, 615d than as shown in FIG. 6. In some examples, the camera sensors 615a, 615b, 615c, 615d of the device 610 may have a different FOV than as shown in FIG. 6.

In one or more examples, during operation of the process 600 for detecting one or more objects, the camera sensors 615a, 615b of the device 610 (e.g., vehicle) can obtain (e.g., within their FOV) images 620a, 620b, 620c, 620d of the environment of the device 610. In one or more examples, each of the images 620a, 620b, 620c, 620d may be a 2D image. In some examples, each of the images 620a, 620b, 620c, 620d can have a high resolution.

After the camera sensors 615a, 615b, 615c, 615d of the device 610 (e.g., vehicle) obtain the images 620a, 620b, 620c, 620d of the environment of the device 610, the device 610 (e.g., one or more processors of the device 610) can downsample 625 the images 620a, 620b, 620c, 620d to produce downsampled images (e.g., by downsampling image 620a to generate downsampled image 630). In one or more examples, the device 610 can downsample 625 images (e.g., with a high resolution) to produce downsampled images that have a lower resolution and/or include a lower number of images. In one or more examples, the images 620a, 620b, 620c, 620d (e.g., with a high resolution) can have a higher resolution than the downsampled images (e.g., image 620a has a higher resolution than downsampled image 630). In some cases, a downsampled image can be generated for each of the images 620a, 620b, 620c, 620d (e.g., for a total of four downsampled images). After the downsampled images (e.g., downsampled image 630) have been produced, an encoder 635 of the device 610 can extract a plurality of features from the downsampled images.

In one or more examples, the downsampling 625 may be optional in some aspects, in which case the process 600 may not downsample 625 the images 620a, 620b, 620c, 620d. In such examples, the encoder 635 of the device 610 can extract a plurality of features from the images 620a, 620b, 620c, 620d.

After the plurality of features have been extracted, the device 610 (e.g., one or more processors of the device 610) can perform BEV feature projection 640 by projecting the plurality of features to a BEV. After the plurality of features have been projected to a BEV, a first detector 650a (e.g., detector stage 1) can determine, based on the plurality of extracted features (e.g., with a BEV), a first detection of the one or more objects and 3D coordinates 655 (e.g., world coordinates) for the one or more objects.

The device 610 can then perform a 3D to 2D back-projection by back-projecting the one or more object detections in 3D coordinates 655 back to the original 2D sensor space, which are the 2D images 620a, 620b, 620c, 620d in this case. As such, the device 610 (e.g., one or more processors of the device 610) can back-project the 3D coordinates of the one or more objects onto the one or more 2D images 620a, 620b, 620c, 620d.

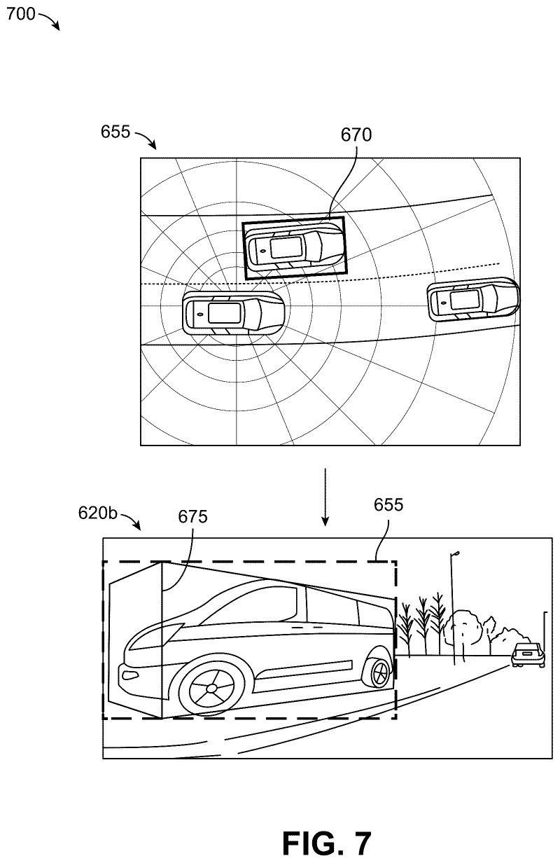

FIG. 7 shows details of the 3D to 2D back-projection. In particular, FIG. 7 is a diagram illustrating an example of details 700 of the 3D to 2D back-projection performed in the process 600 of FIG. 6. In FIG. 7, a 3D object detection 670 in 3D coordinates 655 is shown. The 3D object detection 670 can be projected back to the coordinate system of any of the camera sensors 615a, 615b, 615c, 615d (e.g., of the 2D images 620a, 620b, 620c, 620d) by using calibration information (e.g., for the camera sensors 615a, 615b, 615c, 615d). From the 2D back-projections (e.g., 2D back-projection 675) of the 3D object detections (e.g., 3D object detection 670), the device 610 (e.g., one or more processors of the device 610) can determine one or more regions (e.g., region 665) from the 2D images 620a, 620b, 620c, 620d (e.g., from image 620b) that are relevant for further processing (e.g., based on the 3D coordinates 655 of the one or more objects). In one or more examples, each region of the one or more regions (e.g., region 665) may be in the form of a bounding box within its associated 2D image (e.g., image 620b).

In one or more examples, for each 3D object detection, the device 610 (e.g., one or more processors of the device 610) can define the one or more regions from a selected subset of the camera sensors 615a, 615b, 615c, 615d in which detection of one or more objects is visible. In one or more examples, the device 610 (e.g., one or more processors of the device 610) can determine the subset of camera sensors 615a, 615b, 615c, 615d for the one or more regions based on: the subset of camera sensors capturing images or having views within which the one or more objects are centrally located (e.g., more centrally located as compared to the location of the one or more objects within one or more images or views of one or more other camera sensors), the subset of camera sensors capturing images or having views where the one or more objects are least occluded as compared to images captured or views of other camera sensors of the one or more camera sensors, and/or machine learning training for selecting the subset of the camera sensors.

The device 610 (e.g., one or more processors of the device 610) can then extract the relevant sensor data from the selected subset of the camera sensors 615a, 615b, 615c, 615d. For computational efficiency, only one region (e.g., region 665) may be selected for each 3D detection (e.g., 3D object detection 670). However, detection performance can be improved by fusing together information from multiple camera sensors (e.g., camera sensors 615a, 615b, 615c, 615d).

Referring back to the process 600 of FIG. 6, after the one or more regions (e.g., region 665) of at least one of the one or more images (e.g., image 620b) have been determined, a second detector 650b (e.g., detector stage 2) can determine, based on the one or more regions (e.g., region 665), a second detection of the one or more objects (e.g., object 685) and 3D coordinates 680 (e.g., world coordinates) for the one or more objects. In some cases, the second detector 650b may or may not be a detector in itself. For example, in some cases, the second detector 650b may be a classifier determining if an extracted region from the first detector 650a contains an object of interest or not or if the object in the region possesses a certain attribute. In another example, the second detector 650b may be a regressor estimating a property, or set of properties, of the object in the region. In another example, the second detector 650b can be a combination of an object detector, a classifier, and/or a regressor. In one or more examples, the determining, by the second detector 650b, of the second detection of the one or more objects can be further based on: the one or more regions being processed individually, at least portions of the one or more regions being processed as a single composite region comprising the at least portions of the one or more regions, and/or the one or more regions being processed with one or more cross-attention layers of a transformer neural network applied to the one or more regions. In some cases, the second detector 650b can eliminate false positives (e.g., objects that are falsely detected as relevant objects by the first detector 650a can be discovered to be irrelevant or nonexistent by the second detector 650b). The false positive detection capability of the second detector 650b is illustrated by the elongated object 656 in the 3D coordinate space 655 that has disappeared in the 3D coordinate space 680.

In one or more aspects, if only one region (e.g., region 665) is utilized for detection, a subset of the camera sensors (e.g., camera sensor 615a or camera sensor 615b) for providing one or more 2D images (e.g., image 620b) including the region (e.g., region 665) may be selected in a variety of different ways. In one or more examples, a subset of the camera sensors for providing one or more 2D images including the region can be selected in which detection of one or more objects is most central. In some examples, a subset of the camera sensors for providing one or more 2D images including the region can be selected in which one or more objects is least occluded (e.g., based on an occlusion estimate from the first detector stage, such as first detector 650a). In one or more examples, a subset of the camera sensors for providing one or more 2D images including the region can be selected based on more complex criteria or rules (e.g., which may be statistically determined to be effective). In some examples, the first detector may be trained to select which subset of the camera sensors (e.g., for providing one or more 2D images including the region) to use for the second stage (e.g., using an end-to-end training of the system). In some aspects, when multiple regions (e.g., region 665) are being utilized for detection, the selection of the subset of the camera sensors (e.g., camera sensor 615a or camera sensor 615b) for providing one or more 2D images (e.g., image 620b) including the multiple regions (e.g., region 665) may be based on similar criteria.

In one or more aspects, the extraction (e.g., determining) of the one or more regions can be performed in multiple different ways. In one or more examples, for each region, raw sensor data (e.g., image patches) or patches from feature maps (e.g., from the encoder part of the first detector stage) can be extracted. In some examples, a region may be in the form of a tight bounding box around an object, a bounding box with a certain margin outside of the object, or a selected part of the object detection. In one or more examples, the extracted region can preferably be resampled to a fixed size.

In some aspects, information from multiple regions can be combined (e.g., fused together) in multiple different ways. In one or more examples, a second stage detector can be applied on each patch (e.g., region) individually, and the output from the second stage detector can be combined. In some examples, image patches (e.g., regions) or feature maps may be stacked together. In one or more examples, different parts of regions may be combined into one image patch (e.g., based on visibility of one or more objects). In some examples, a model using cross-attention may be applied to multiple patches (e.g., regions). In one or more examples, a multi-stage approach may be applied where patches (e.g., regions) are extracted only when necessary (e.g., when the confidence from a previous patch is low).

In one or more aspects, a camera sensor (e.g., from which to extract the region to serve as input to the second detector stage) can be selected in order to maximize the performance on a training or validation data set. The selection can be made individually for each detection produced by the first detector stage. Preferably end-to-end training can be used to train the first detector to generate an output identifying the camera sensor to use (e.g., the first and second detector stages can be trained together in order to maximize the combined performance). Alternatively, the first detector stage may be initially trained separately. The second stage can then be trained and evaluated on all camera sensors, for each detection from the first stage, while keeping track of which camera sensor yielded the best results. This resultant information may then be used to retrain the first detector stage to provide the sensor selection, or to generate a statistical model or database that can be queried to return the statistically best camera sensor to select (e.g., based on detection position and pose).

In one or more aspects, fusion of multiple regions may be performed in a variety of different ways. In one or more examples, a second detector stage can be applied on each patch individually and the output from the second detector stage can be combined. In some examples, a CNN can be applied on each patch (e.g., region) to obtain a set of confidences. The confidences can then be combined (e.g., using a mean or maximum value). In one or more examples, a model using cross-attention can be applied to multiple patches (e.g., regions).

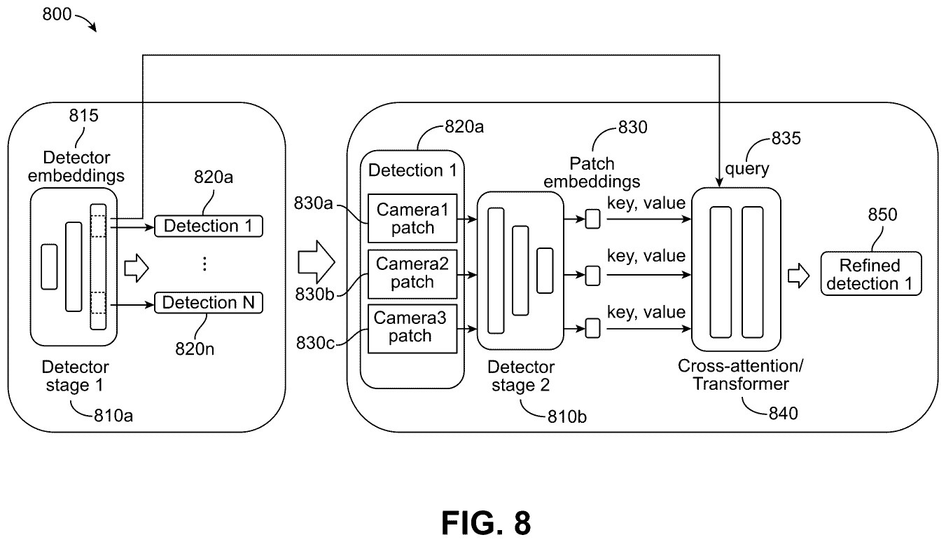

FIG. 8 shows an example of a model using cross-attention being applied to multiple regions. In particular, FIG. 8 is a diagram illustrating an example of a process 800 of applying cross-attention to multiple regions. In FIG. 8, during operation of the process 800 of applying cross-attention to multiple regions, a first detector 810a (e.g., detector stage 1) of a device (e.g., vehicle) can extract feature vectors and embeddings 815 from N number of detected objects (e.g., detection 1 820a to detection n 820n). A second detector 810b (e.g., detector stage 2) of the device can compute feature vectors and embeddings from each extracted image patch (e.g., camera 1 patch 830a, camera 2 patch 830b, camera 3 patch 830c). In one or more examples, each extracted image patch (e.g., camera 1 patch 830a, camera 2 patch 830b, camera 3 patch 830c) is from an image obtained by a different camera sensor (e.g., camera 1, camera 2, and camera 3). Using a transformer network, the first stage embeddings 815 can act as queries, and the patch embeddings 830 (e.g., or parts thereof) can act as keys and values to combine information from all of the patches (e.g., camera 1 patch 830a, camera 2 patch 830b, camera 3 patch 830c).

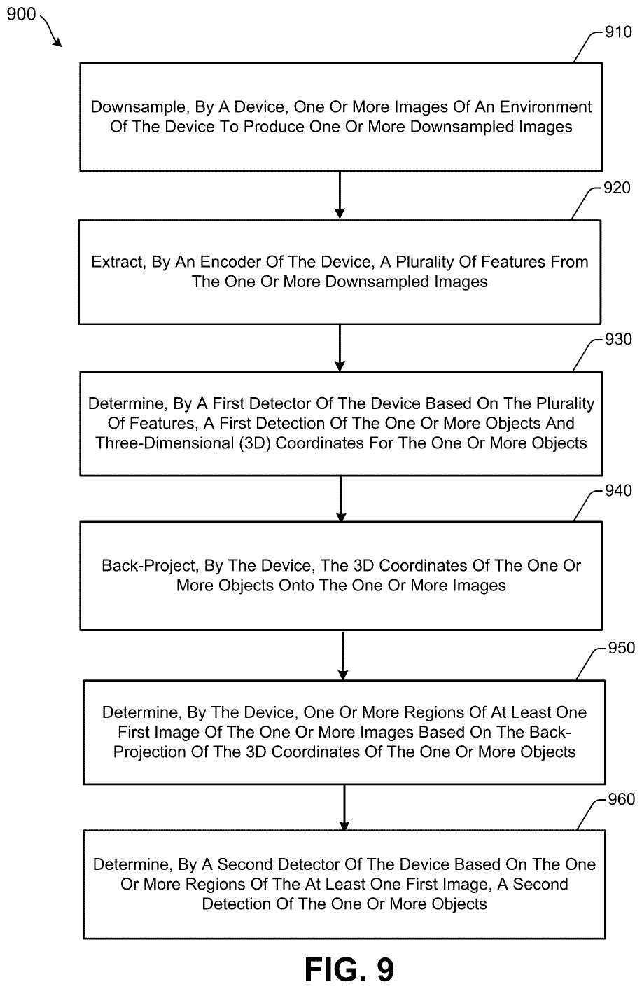

FIG. 9 is a flow chart illustrating an example of a process 900 for object detection. The process 900 can be performed by a computing device (e.g., image capture and processing system 100 of FIG. 1, system 200 of FIG. 2, source vehicle 502 of FIG. 5, vehicle 610 of FIG. 6, and/or a computing device or computing system 1000 of FIG. 10) or by a component or system (e.g., a chipset, one or more processors such as one or more central processing units (CPUs), digital signal processors (DSPs), graphics processing units (GPUs), any combination thereof, and/or other type of processor(s), or other component or system) of the computing device. For instance, the computing device can be a vehicle or a device or system of the vehicle (e.g., an ADAS system of the vehicle). The operations of the process 900 may be implemented as software components that are executed and run on one or more processors (e.g., processor 1010 of FIG. 10 or other processor(s)). Further, the transmission and reception of signals by the computing device in the process 900 may be enabled, for example, by one or more antennas and/or one or more transceivers (e.g., wireless transceiver(s)).

At block 910, the computing device (or component thereof) can extract, using an encoder (which can in some cases be part of the computing device), a plurality of features from one or more images of an environment of the apparatus. The one or more images can be two-dimensional images. In some aspects, the computing device (or component thereof) can downsample the one or more images of the environment to produce one or more downsampled images (e.g., downsampled image 630 of FIG. 6), where the one or more images have a higher resolution than the one or more downsampled images. In such aspects, the plurality of features can be extracted from the one or more downsampled images (e.g., as shown in FIG. 6). In some cases, the one or more images include a larger number of images than the one or more downsampled images.

At block 920, the computing device (or component thereof) can determine (e.g., using first detector 650a of FIG. 6), based on the plurality of features, a first detection of one or more objects and three-dimensional (3D) coordinates (e.g., world coordinates) for the one or more objects. In some cases, the computing device (or component thereof) can project the plurality of features to a bird's eye view (BEV) (e.g., BEV feature projection 640 of FIG. 6). In such cases, the detection can be based on the BEV projected features.

At block 930, the computing device (or component thereof) can back-project the 3D coordinates of the one or more objects onto the one or more images.

At block 940, the computing device (or component thereof) can determine one or more regions of at least one first image of the one or more images based on the back-projection of the 3D coordinates of the one or more objects.

At block 950, the computing device (or component thereof) can determine (e.g., using second detector 650b of FIG. 6), based on the one or more regions of the at least one first image, a second detection of the one or more objects. In some cases, the second detector can additionally use information (e.g., features) from the first detector. For instance, for each region of the one or more regions, the computing device (or component thereof) can extract one or more patches of sensor data or one or more patches of features of the plurality of features.

In some aspects, the computing device (or component thereof) can include one or more camera sensors. For instance, the one or more camera sensors are configured to obtain the one or more images of the environment of the apparatus. In some aspects, the computing device (or component thereof) can determine a subset of camera sensors of the one or more camera sensors for the one or more regions of the at least one first image based on at the subset of camera sensors having views within which the one or more objects are more centrally located than within one or more views of one or more other camera sensors, the subset of camera sensors having views where the one or more objects are least occluded as compared to views of other camera sensors of the one or more camera sensors, machine learning training for selecting the subset of camera sensors, any combination thereof, and/or based on other factors.

In some cases, the computing device (or component thereof) can determine the second detection of the one or more objects further based on the one or more regions being processed individually. In some examples, the computing device (or component thereof) can determine the second detection of the one or more objects further based on at least portions of the one or more regions being processed as a single composite region including the at least portions of the one or more regions. In some cases, the computing device (or component thereof) can determine the second detection of the one or more objects further based on the one or more regions being processed with one or more cross-attention layers of a transformer neural network applied to the one or more regions.

In some cases, the computing device of process 900 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 900 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a block diagram illustrating an example of a computing system 1000, which may be employed for an efficient two-stage multi-view 3D object detection. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LiDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of”' a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of”' a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. An apparatus for object detection, the apparatus comprising: at least one memory; and at least one processor coupled to the at least one memory and configured to: extract, using an encoder, a plurality of features from one or more images of an environment of the apparatus; determine, based on the plurality of features, a first detection of one or more objects and three-dimensional (3D) coordinates for the one or more objects; back-project the 3D coordinates of the one or more objects onto the one or more images; determine one or more regions of at least one first image of the one or more images based on the back-projection of the 3D coordinates of the one or more objects; and determine, based on the one or more regions of the at least one first image, a second detection of the one or more objects.
Aspect 2. The apparatus of Aspect 1, wherein the at least one processor is configured to downsample the one or more images of the environment to produce one or more downsampled images, wherein the plurality of features are extracted from the one or more downsampled images.
Aspect 3. The apparatus of Aspect 2, wherein the one or more images have a higher resolution than the one or more downsampled images.
Aspect 4. The apparatus of any of Aspects 2 or 3, wherein the one or more images include a larger number of images than the one or more downsampled images.
Aspect 5. The apparatus of any of Aspects 1 to 4, wherein the one or more images are two-dimensional images.
Aspect 6. The apparatus of any of Aspects 1 to 5, further comprising one or more camera sensors, wherein the one or more camera sensors are configured to obtain the one or more images of the environment of the apparatus.
Aspect 7. The apparatus of Aspect 6, wherein the at least one processor is configured to determine a subset of camera sensors of the one or more camera sensors for the one or more regions of the at least one first image based on at least one of: the subset of camera sensors having views within which the one or more objects are more centrally located than within one or more views of one or more other camera sensors, the subset of camera sensors having views where the one or more objects are least occluded as compared to views of other camera sensors of the one or more camera sensors, or machine learning training for selecting the subset of camera sensors.
Aspect 8. The apparatus of any of Aspects 1 to 7, wherein the at least one processor is configured to determine the second detection of the one or more objects further based on the one or more regions being processed individually.
Aspect 9. The apparatus of any of Aspects 1 to 8, wherein the at least one processor is configured to determine the second detection of the one or more objects further based on at least portions of the one or more regions being processed as a single composite region comprising the at least portions of the one or more regions.
Aspect 10. The apparatus of any of Aspects 1 to 9, wherein the at least one processor is configured to determine the second detection of the one or more objects further based on the one or more regions being processed with one or more cross-attention layers of a transformer neural network applied to the one or more regions.
Aspect 11. The apparatus of any of Aspects 1 to 10, wherein the at least one processor is configured to project the plurality of features to a bird's eye view (BEV).
Aspect 12. The apparatus of any of Aspects 1 to 11, wherein the 3D coordinates are world coordinates.
Aspect 13. The apparatus of any of Aspects 1 to 12, wherein the apparatus is a vehicle or a computing device of the vehicle.
Aspect 14. The apparatus of any of Aspects 1 to 13, wherein the at least one processor is configured to, for each region of the one or more regions, extract one or more patches of sensor data or one or more patches of features of the plurality of features.
Aspect 15. A method of object detection at a device, the method comprising: extracting, by an encoder of the device, a plurality of features from one or more images of an environment of the device; determining, based on the plurality of features, a first detection of one or more objects and three-dimensional (3D) coordinates for the one or more objects; back-projecting the 3D coordinates of the one or more objects onto the one or more images; determining one or more regions of at least one first image of the one or more images based on the back-projection of the 3D coordinates of the one or more objects; and determining, based on the one or more regions of the at least one first image, a second detection of the one or more objects.
Aspect 16. The method of Aspect 15, further comprising downsampling the one or more images of the environment to produce one or more downsampled images, wherein the plurality of features are extracted from the one or more downsampled images.
Aspect 17. The method of Aspect 16, wherein the one or more images have a higher resolution than the one or more downsampled images.
Aspect 18. The method of any of Aspects 16 or 17, wherein the one or more images include a larger number of images than the one or more downsampled images.
Aspect 19. The method of any of Aspects 15 to 18, wherein the one or more images are two-dimensional images.
Aspect 20. The method of any of Aspects 15 to 19, further comprising obtaining, by one or more camera sensors of the device, the one or more images of the environment of the device.
Aspect 21. The method of Aspect 20, further comprising determining, by the device, a subset of camera sensors of the one or more camera sensors for the one or more regions of the at least one first image based on at least one of: the subset of camera sensors having views within which the one or more objects are more centrally located than within one or more views of one or more other camera sensors, the subset of camera sensors having views where the one or more objects are least occluded as compared to views of other camera sensors of the one or more camera sensors, or machine learning training for selecting the subset of camera sensors.
Aspect 22. The method of any of Aspects 15 to 21, wherein determining the second detection of the one or more objects is further based on the one or more regions being processed individually.
Aspect 23. The method of any of Aspects 15 to 22, wherein determining the second detection of the one or more objects is further based on at least portions of the one or more regions being processed as a single composite region comprising the at least portions of the one or more regions.
Aspect 24. The method of any of Aspects 15 to 23, wherein determining the second detection of the one or more objects is further based on the one or more regions being processed with one or more cross-attention layers of a transformer neural network applied to the one or more regions.
Aspect 25. The method of any of Aspects 15 to 24, further comprising projecting, by the device, the plurality of features to a bird's eye view (BEV).
Aspect 26. The method of any of Aspects 15 to 25, wherein the 3D coordinates are world coordinates.
Aspect 27. The method of any of Aspects 15 to 26, wherein the device is a vehicle or a computing device of the vehicle.
Aspect 28. The method of any of Aspects 15 to 27, further comprising, for each region of the one or more regions, extracting one or more patches of sensor data or one or more patches of features of the plurality of features.
Aspect 29. A non-transitory computer-readable medium having stored thereon instructions that, when executed by one or more processors, cause the one or more processors to perform operations according to any of Aspects 15 to 28.
Aspect 30. An apparatus including one or more means for performing operations according to any of Aspects 15 to 28.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for object detection, the apparatus comprising:
at least one memory; and
at least one processor coupled to the at least one memory and configured to:
extract, using an encoder, a plurality of features from one or more images of an environment of the apparatus;
determine, based on the plurality of features, a first detection of one or more objects and three-dimensional (3D) coordinates for the one or more objects;
back-project the 3D coordinates of the one or more objects onto the one or more images;
determine one or more regions of at least one first image of the one or more images based on the back-projection of the 3D coordinates of the one or more objects; and
determine, based on the one or more regions of the at least one first image, a second detection of the one or more objects.

2. The apparatus of claim 1, wherein the at least one processor is configured to downsample the one or more images of the environment to produce one or more downsampled images, wherein the plurality of features are extracted from the one or more downsampled images.

3. The apparatus of claim 2, wherein the one or more images have a higher resolution than the one or more downsampled images.

4. The apparatus of claim 2, wherein the one or more images include a larger number of images than the one or more downsampled images.

5. The apparatus of claim 1, wherein the one or more images are two-dimensional images.

6. The apparatus of claim 1, further comprising one or more camera sensors, wherein the one or more camera sensors are configured to obtain the one or more images of the environment of the apparatus.

7. The apparatus of claim 6, wherein the at least one processor is configured to determine a subset of camera sensors of the one or more camera sensors for the one or more regions of the at least one first image based on at least one of: the subset of camera sensors having views within which the one or more objects are more centrally located than within one or more views of one or more other camera sensors, the subset of camera sensors having views where the one or more objects are least occluded as compared to views of other camera sensors of the one or more camera sensors, or machine learning training for selecting the subset of camera sensors.

8. The apparatus of claim 1, wherein the at least one processor is configured to determine the second detection of the one or more objects further based on the one or more regions being processed individually.

9. The apparatus of claim 1, wherein the at least one processor is configured to determine the second detection of the one or more objects further based on at least portions of the one or more regions being processed as a single composite region comprising the at least portions of the one or more regions.

10. The apparatus of claim 1, wherein the at least one processor is configured to determine the second detection of the one or more objects further based on the one or more regions being processed with one or more cross-attention layers of a transformer neural network applied to the one or more regions.

11. The apparatus of claim 1, wherein the at least one processor is configured to project the plurality of features to a bird's eye view (BEV).

12. The apparatus of claim 1, wherein the 3D coordinates are world coordinates.

13. The apparatus of claim 1, wherein the apparatus is a vehicle or a computing device of the vehicle.

14. The apparatus of claim 1, wherein the at least one processor is configured to, for each region of the one or more regions, extract one or more patches of sensor data or one or more patches of features of the plurality of features.

15. A method of object detection at a device, the method comprising:
extracting, by an encoder of the device, a plurality of features from one or more images of an environment of the device;
determining, based on the plurality of features, a first detection of one or more objects and three-dimensional (3D) coordinates for the one or more objects;
back-projecting the 3D coordinates of the one or more objects onto the one or more images;
determining one or more regions of at least one first image of the one or more images based on the back-projection of the 3D coordinates of the one or more objects; and
determining, based on the one or more regions of the at least one first image, a second detection of the one or more objects.

16. The method of claim 15, further comprising downsampling the one or more images of the environment to produce one or more downsampled images, wherein the plurality of features are extracted from the one or more downsampled images.

17. The method of claim 15, further comprising determining, by the device, a subset of camera sensors of a plurality of camera sensors for the one or more regions of the at least one first image based on at least one of: the subset of camera sensors having views within which the one or more objects are more centrally located than within one or more views of one or more other camera sensors, the subset of camera sensors having views where the one or more objects are least occluded as compared to views of other camera sensors of the one or more camera sensors, or machine learning training for selecting the subset of camera sensors.

18. The method of claim 15, wherein determining the second detection of the one or more objects is further based on at least portions of the one or more regions being processed as a single composite region comprising the at least portions of the one or more regions.

19. The method of claim 15, wherein determining the second detection of the one or more objects is further based on the one or more regions being processed with one or more cross-attention layers of a transformer neural network applied to the one or more regions.

20. The method of claim 15, further comprising projecting, by the device, the plurality of features to a bird's eye view (BEV).
